(19) United States
(12) Patent Application Publication
(10) Pub. No.: US 2008/0034527 A1
(43) Pub. Date: Feb. 14, 2008

(54) Transparent Windshield Wiper Device

(76) Inventor: Dillon D. George, Chattanooga, TN (US)

Correspondence Address: HARSHAW RESEARCH, INC., 210 W. TECUMSEH STREET, OTTAWA, KS, 66067, US

(21) Appl. No.: 11/768,278

(22) Filed: Jun. 26, 2007

Related U.S. Application Data
(60) Provisional application No. 60/836,276, filed on Aug. 8, 2006.

(51) Int. Cl. B60S 1/04; B60S 1/34; B60S 1/38

(52) U.S. Cl. 15/250.001; 15/250.351; 15/250.361

(57) ABSTRACT

A transparent windshield wiper device according to the present invention includes a transparent wiper arm and a transparent attachment bracket pivotally mounted to the transparent wiper arm. A transparent blade is removably coupled to the transparent attachment bracket. The transparent wiper arm and transparent attachment bracket may be constructed of polymethylene terephthalate, cellulose acetate butyrate, polycarbonate, or glycol modified polyethylene terephthalate. The wiper blade is constructed of a malleable and transparent material and includes internal fiber reinforcement that is also transparent. Further, the wiper blade is UV stabilized and includes an antiglare layer.

### CROSS REFERENCE TO RELATED APPLICATION

This non-provisional patent application claims the benefit of provisional application Ser. No. 60/836,276 filed on Aug. 8, 2006.

### BACKGROUND OF THE INVENTION

The present windshield wiper device according to the present invention relates generally to windshield wipers and, more particularly, to a transparent windshield wiper device that minimizes the visual impairment of a driver that may otherwise be caused by traditional wipers themselves.

Driving an automobile during heavy or even moderate rain can become frustrating to a driver. This experience is even more difficult when a driver's vision is obstructed by the bright lights of an oncoming car. Even further, the generally dark and opaque character of a windshield wiper system may obstruct the view of the driver and contribute to an already difficult or unsafe condition.

Various devices have been proposed in the art for making portions of a windshield assembly translucent or less of an obstruction to the vision of a driver. Although presumably effective for their intended purposes, the existing devices and proposals either utilize inferior materials that degrade the strength or durability of the wiper system, do not provide transparency to all components of the wiper system, or fail to address the glare of oncoming vehicle headlights.

Therefore, it would be desirable to have a transparent windshield wiper device that provides transparency to all major wiper components without degrading the strength and durability of the device. Further, it would be desirable to have a windshield wiper device that minimizes glare that may otherwise be caused by the lights of oncoming vehicles shining upon the transparent wiper device material.

### SUMMARY OF THE INVENTION

Accordingly, a transparent windshield wiper device according to the present invention includes a transparent wiper arm and a transparent attachment bracket pivotally mounted to the transparent wiper arm. A transparent blade is removably coupled to the transparent attachment bracket. The transparent wiper arm and transparent attachment bracket may be constructed of polymethylene terephthalate, cellulose acetate butyrate, polycarbonate, or glycol modified polyethylene terephthalate. The wiper blade is constructed of a malleable and transparent material and includes internal fiber reinforcement that is also transparent. Further, the wiper blade is UV stabilized and includes an antiglare layer.

Therefore, a general object of the present invention is to provide a transparent windshield wiper device in which all major components are constructed of a transparent material for minimizing any obstruction to the view of a driver during use.

Another object of this invention is to provide a transparent windshield wiper device, as aforesaid, in which the transparent construction of the device does not degrade the strength or durability of the device.

Still another object of this invention is to provide a transparent windshield wiper device, as aforesaid, that minimizes glare that may otherwise be caused by the headlights of an oncoming automobile passing through the transparent materials.

Yet another object of this invention is to provide a transparent windshield wiper device, as aforesaid, having a wiper blade that is UV stabilized.

A further object of this invention is to provide a transparent windshield device, as aforesaid, in which the wiper blade is constructed of a malleable material that is reinforced with glass fibers.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a transparent windshield wiper device according to a preferred embodiment of the present invention;

FIG. 2 is an exploded view of the windshield wiper device as in FIG. 1;

FIG. 3a is a top view of the wiper blade as in FIG. 2; and

FIG. 3b is a sectional view of the wiper blade taken along line 3b-3b of FIG. 3a.

### DESCRIPTION OF THE PREFERRED EMBODIMENT

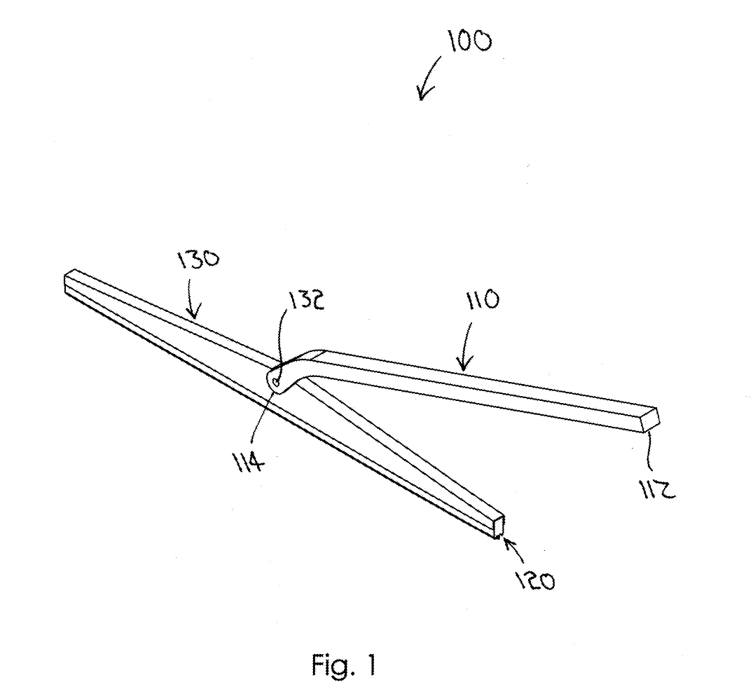

A transparent windshield wiper device 100 according to the present invention will now be described in detail with reference to FIGS. 1 through 3b of the accompanying drawings. More particularly, a transparent windshield wiper device 100 according to the current invention includes a transparent wiper arm 110 and a transparent wiper blade 120.

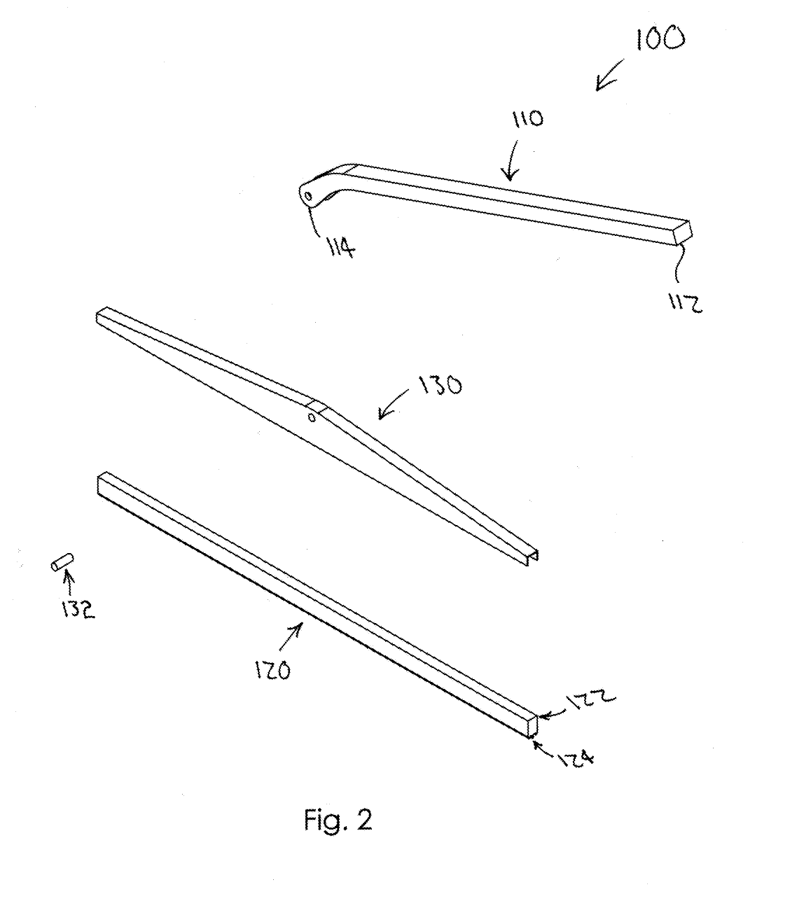

As shown in FIGS. 1 and 2, the transparent wiper arm 110 has first and second ends 112, 114. The first end 112 may be configured to be operatively coupled to an oscillating device, such as a windshield wiper motor (not shown). The wiper arm 110 may be constructed of a rigid and transparent plastic or another appropriate rigid and transparent material. Examples of suitable materials may include polymethlamethacrylate (commonly referred to as “Acrylic”), cellulose acetate butyrate (commonly referred to as Butyrate), polycarbonate (e.g., Lexan), and/or glycol modified polyethylene terephthalate (e.g., PETG). A “transparent” article as used herein should be understood to mean an article that has the ability to transmit rays of light through its substance in a “see through” manner, whether clear or translucent.

The wiper blade 120 may be operatively coupled to the wiper arm 110 second end 114. For example, as shown in FIGS. 1 and 2, a transparent attachment bracket 130 may be mounted to the wiper arm second end 114 (i.e., using a track system, clips, or any other appropriate method) and may pivotally couple (i.e., using pin 132) the wiper blade 120 to the wiper arm 110. The attachment bracket 130 may be constructed of a rigid and transparent plastic or another appropriate rigid and transparent material. Examples of suitable materials may include polymethlamethacrylate (commonly referred to as “Acrylic”), cellulose acetate butyrate (commonly referred to as Butyrate), polycarbonate (e.g., Lexan), and/or glycol modified polyethylene terephthalate (e.g., PETG).

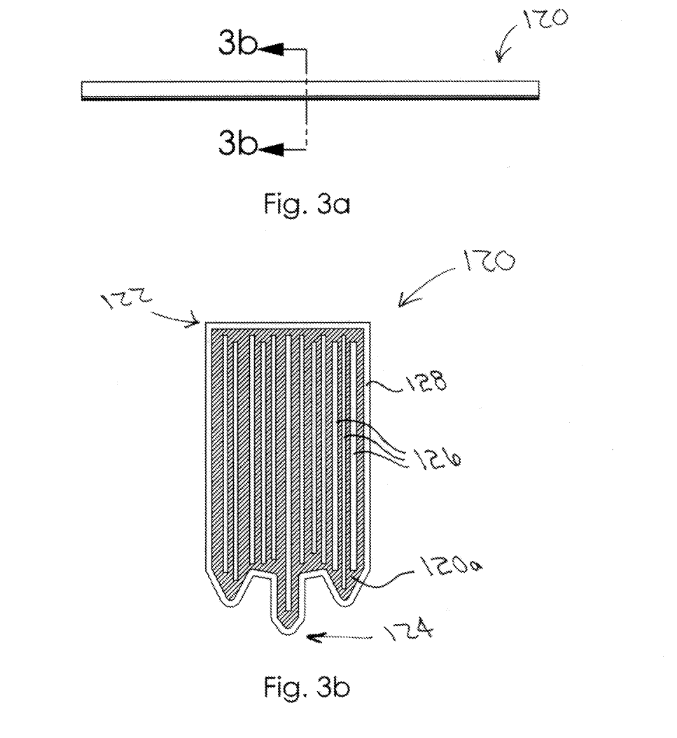

The wiper blade 120 includes upper and lower ends 122, 124 (FIGS. 2 and 3b). The wiper blade 120 may be removably coupled to the attachment bracket 130 or may otherwise be selectively separable from the oscillating device. For example, the attachment bracket 130 may be separable from the wiper arm 110, the wiper arm 110 may be separable from the oscillating device, or the wiper arm 110 may itself be separable. The wiper blade 120 may be constructed of a flexible (or in other words malleable) transparent material 120a that may preferably be UV stabilized so that it does not break down during its product life due to exposure to the sun. Examples of suitable materials may include silicone and a material marketed by the Bayer Corporation under the trademark Desmopan. To provide additional strength, the wiper blade 120 may include internal fiber reinforcement 126 (FIG. 3b) that is transparent. The internal fiber reinforcement 126 may include glass fibers, for example, and may be oriented to extend generally from the upper end 122 to the lower end 124. In other words, the internal fiber reinforcement 126 may be oriented vertically, and need not extend entirely from the upper end 122 to the lower end 124. An antiglare layer 128 may be included (FIG. 3b) to reduce any glare from the wiper blade 120. This antiglare layer 128 may be, for example, a polarizing filter or a transparent material with low reflectivity.

In use, the wiper arm 110 is operatively coupled to the oscillating device, and the oscillating device selectively causes the wiper arm 110 to oscillate adjacent a windshield. “Windshield” as used herein should be understood to mean a vehicle (automobile, watercraft, aircraft, snowmobile, etc.) window, including a foremost window, a rearmost window, and/or a side window. The pivotal attachment between the attachment bracket 130 and the wiper arm 110 may allow the wiper blade 120 to generally follow the contour of the windshield, and the flexible nature of the wiper blade 120 may allow the wiper blade 120 to maintain contact with the windshield to remove water and/or other obstructions from at least a portion of the windshield. The transparent nature of the wiper arm 110, the wiper blade 120, and the attachment bracket 130 as discussed above may allow items to be seen through the wiper arm 110, the wiper blade 120, and the attachment bracket 130 in either a clear or translucent manner. As such, a driver or occupant may be able to easily view items through the windshield with minimal distraction from the transparent windshield wiper device 100. The UV stabilization of the wiper blade 120 may ensure that the wiper blade 120 does not break down during its product life due to exposure to the sun, and the internal fiber reinforcement 126 may strengthen the wiper blade 120 while allowing the wiper blade 120 to remain flexible. The antiglare layer 128 may minimize glare from the wiper blade 120 that could otherwise be distracting.

It is understood that while certain forms of this invention have been illustrated and described, it is not limited thereto except insofar as such limitations are included in the following claims and allowable functional equivalents thereof.

1. A transparent windshield wiper device, comprising:
a transparent wiper arm;
a transparent attachment bracket pivotally mounted to said transparent wiper arm; and
a transparent wiper blade removably coupled to said transparent attachment bracket.

2. The transparent windshield wiper device as in claim 1, wherein:
said transparent wiper arm is constructed of a rigid and transparent plastic;
said transparent attachment bracket is constructed of a rigid and transparent plastic; and
said transparent wiper blade is constructed of a malleable and transparent material.

3. The transparent windshield wiper device as in claim 1, wherein at least one of said transparent wiper arm and said transparent attachment bracket is constructed of at least one of polymethlamethacrylate, cellulose acetate butyrate, polycarbonate, and glycol modified polyethylene terephthalate.

4. The transparent windshield wiper device as in claim 1, wherein said transparent wiper blade is constructed of at least one of Desmopan and silicone.

5. The transparent windshield wiper device as in claim 1, wherein:
said transparent wiper blade is constructed of a malleable and transparent material; and
said transparent wiper blade includes internal fiber reinforcement, said internal fiber reinforcement being transparent.

6. The transparent windshield wiper device as in claim 5, wherein said internal fiber reinforcement includes glass fibers.

7. The transparent windshield wiper device as in claim 5, wherein:
said transparent wiper blade has upper and lower ends; and
said internal fiber reinforcement is oriented to extend generally from said upper end to said lower end.

8. The transparent windshield wiper device as in claim 1, wherein said transparent wiper blade is constructed of a malleable and transparent material that is UV stabilized and said transparent wiper blade includes an antiglare layer.

9. The transparent windshield wiper device as in claim 1, wherein:
items can be seen through said transparent wiper arm in a clear manner;
items can be seen through said transparent attachment bracket in a clear manner; and
items can be seen through said transparent wiper blade in a clear manner.

10. The transparent windshield wiper device as in claim 1, wherein:
items can be seen through said transparent wiper arm in a translucent manner;
items can be seen through said transparent attachment bracket in a translucent manner; and
items can be seen through said transparent wiper blade in a translucent manner.

11. A transparent windshield wiper device, comprising:
a transparent wiper arm having first and second ends, said first end being configured to be operatively coupled to an oscillating device; and
a transparent wiper blade operatively coupled to said attachment bracket second end.

12. The transparent windshield wiper device as in claim 11, wherein a transparent attachment bracket pivotally couples said wiper blade to said wiper arm, said attachment bracket being mounted to said wiper arm second end.

13. The transparent windshield wiper device as in claim 12, wherein:
said wiper arm is rigid;
said attachment bracket is rigid; and
said wiper blade is flexible.

14. The transparent windshield wiper device as in claim 13, wherein said wiper arm is constructed of at least one of polymethlamethacrylate, cellulose acetate butyrate, polycarbonate, or glycol modified polyethylene terephthalate.

15. The transparent windshield wiper device as in claim 13, wherein said attachment bracket is constructed of at least one of polymethlamethacrylate, cellulose acetate butyrate, polycarbonate, or glycol modified polyethylene terephthalate.

16. The transparent windshield wiper device as in claim 13, wherein said wiper blade is constructed of Desmopan.

17. The transparent windshield wiper device as in claim 13, wherein said wiper blade includes internal fiber reinforcement, said internal fiber reinforcement being transparent.

18. The transparent windshield wiper device as in claim 17, wherein:
said wiper blade has upper and lower ends; and
said internal fiber reinforcement is oriented to extend generally from said upper end to said lower end.

19. The transparent windshield wiper device as in claim 13, wherein:
said wiper blade is constructed of a malleable and transparent material that is UV stabilized; and
said wiper blade includes an antiglare layer.

20. The transparent windshield wiper device as in claim 12, wherein:
items can be seen through said wiper arm in at least one of a clear manner or a translucent manner;
items can be seen through said attachment bracket in at least one of a clear manner or a translucent manner; and
items can be seen through said wiper blade in at least one of a clear manner or a translucent manner.
